(19) United States
(12) Patent Application Publication
(10) Pub. No.: US 2015/0276199 A1
(43) Pub. Date: Oct. 1, 2015

(54) LED LIGHTING APPARATUS

(71) Applicant: ARTEMIDE S.p.A., Milano (IT)

(72) Inventor: Fabio ZANOLA, Missaglia (IT)

(21) Appl. No.: 14/670,726

(22) Filed: Mar. 27, 2015

(30) Foreign Application Priority Data
Mar. 28, 2014 (IT) MI2014A000547

(51) Int. Cl. F21V 29/74; F21V 29/89; F21V 29/505; F21K 99/00; F21S 8/02

(52) U.S. Cl. CPC F21V 29/74; F21K 9/30; F21S 8/026; F21S 8/024; F21V 29/505; F21V 29/89; F21Y 2101/02

(57) ABSTRACT

A led lighting apparatus, in particular a recessed lighting apparatus, comprises a body, having an internal cavity and extending substantially along and about an axis; and a LED light source housed in the cavity; the body is formed by annular portions about the axis and by rib longitudinal portions joining the annular portions, said portions being shaped so as to provide mechanical-structural support, to act as heat sinks to dissipate heat generated by the light source and to form a plurality of optical sectors having respective optical surfaces coordinated with one another and operating on the light emitted by the light source.

### CROSS-REFERENCE TO RELATED APPLICATIONS

The present application claims priority under 35 U.S.C. §119 to Italian Patent Application. No, M12014A000547, filed Mar. 28, 2014, the entirety of which is incorporated herein by reference.

### FIELD OF THE INVENTION

The present invention relates to a led lighting apparatus, particularly adapted to the use as a recessed lighting apparatus, but also usable in other configurations.

### BACKGROUND OF THE INVENTION

It is known that LED light sources are increasingly widespread in the lighting field. However, the use of LEDs still has some drawbacks that the known lighting devices have not yet completely overcome.

In particular, a persistent problem is the need to dissipate heat generated by the LEDs. Heat sinks are generally used, which however are often relatively bulky and sometimes not fully efficient, especially in the case of recessed lighting apparatuses.

In many known solutions, for example, the heat sink protrudes behind the LEDs, resulting in an increase of the overall depth dimensions of the apparatus and in a reduced efficiency, since the sink remains closed in the recess in which the lighting apparatus is housed, where the heat dissipation is obviously less efficient, due to the lack of circulating air.

In addition, in some cases the sink is formed by a number of assembled pieces or components.

Ultimately, the known apparatuses seem improvable, in particular in terms of constructional simplicity, efficiency, ability of heat dissipation with small overall dimensions.

### SUMMARY OF THE INVENTION

It is an object of the present invention to provide a led lighting apparatus which is, as compared to the known solutions, at least as simple, or simpler, to be manufactured and efficient in use, as well as capable of efficiently dissipating heat even with small overall dimensions.

Therefore, the present invention relates to a led lighting apparatus as defined in essential terms in the appended claim 1 and, in its additional features, in the dependent claims.

In essence, the led lighting apparatus of the invention is characterized in that it has a body which incorporates in itself (thus, in a single component, which may also advantageously consist of a monolithic piece, while being however compact and simple to be manufactured) the optical function (to confer the desired optical properties to the light emitted by the LED source), the heat dissipation function (particularly important with LED sources and especially in recessed applications) and the structural function (by providing the apparatus as a whole and the other components with mechanical support).

The body is formed by portions which are shaped so as to provide mechanical-structural support, to act as heat sinks to dissipate heat generated by the LED source, and to form optical sectors suitably coordinated with one another.

The configuration in sectors of the optical part of the apparatus allows air passages (which concur to the efficiency of the heat dissipation) to be obtained in every configuration and arrangement of the apparatus (both in the position with a vertical axis and in the position with a horizontal axis, hence also in all the intermediate positions), thus allowing for a ventilation by convection of the apparatus in any possible use configurations.

The optical surfaces are directly obtained on the body of the apparatus, with the possibility to be finished both by machining, and (or) by surface post-treatments such as chrome plating, metallization, painting, etc.

In the use for example as a recessed lighting apparatus, a significant improvement compared to that of a traditional apparatus is obtained, both in terms of decrease of the overall dimensions (especially in the depth of the recess), and because the body acting as a heat sink is the same body which form the structural casing of the apparatus and contains the optics of the apparatus, and which thus extends towards the environment (where the heat exchange is promoted), and also because the number of required components is reduced.

### BRIEF DESCRIPTION OF THE DRAWINGS

Further features and advantages of the present invention will become apparent from the description of the following non-limiting embodiments, with reference to the figures of the accompanying drawings, in which:

FIG. 1 is a diagrammatic perspective bottom view of a led lighting apparatus in accordance with the invention;

FIG. 2 is a diagrammatic perspective top view of the apparatus in FIG. 1;

FIG. 3 is a diagrammatic, longitudinal section view with parts removed for clarity of the apparatus in FIG. 1;

FIGS. 4 and 5 are diagrammatic perspective views of other embodiments of the lighting apparatus of the invention;

FIG. 6 is a diagrammatic perspective view with parts removed for clarity of a further embodiment of the apparatus of the invention.

### DETAILED DESCRIPTION OF THE INVENTION

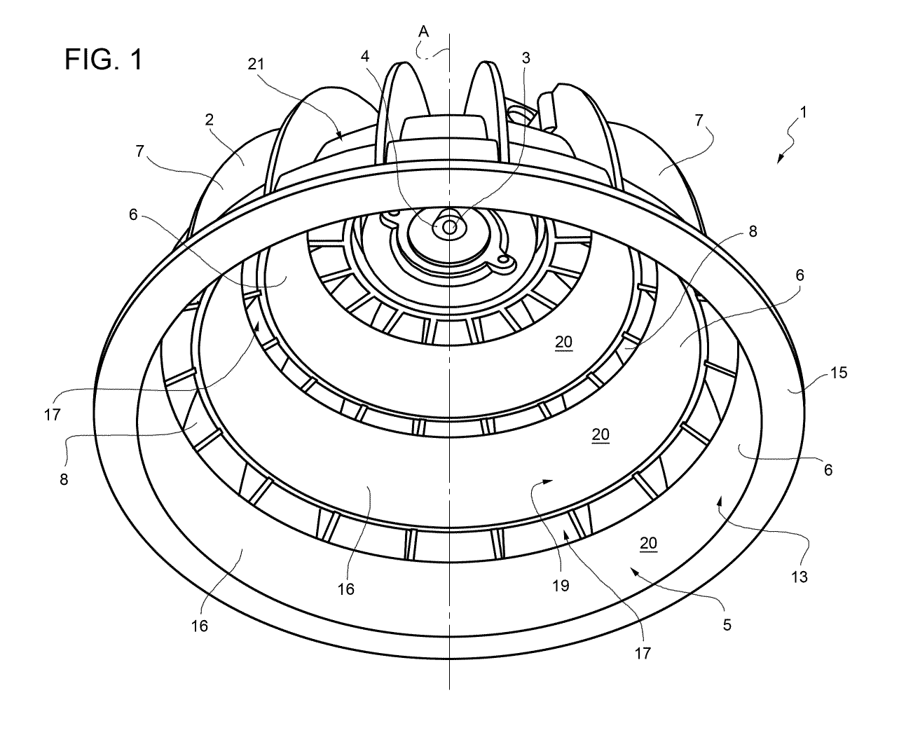

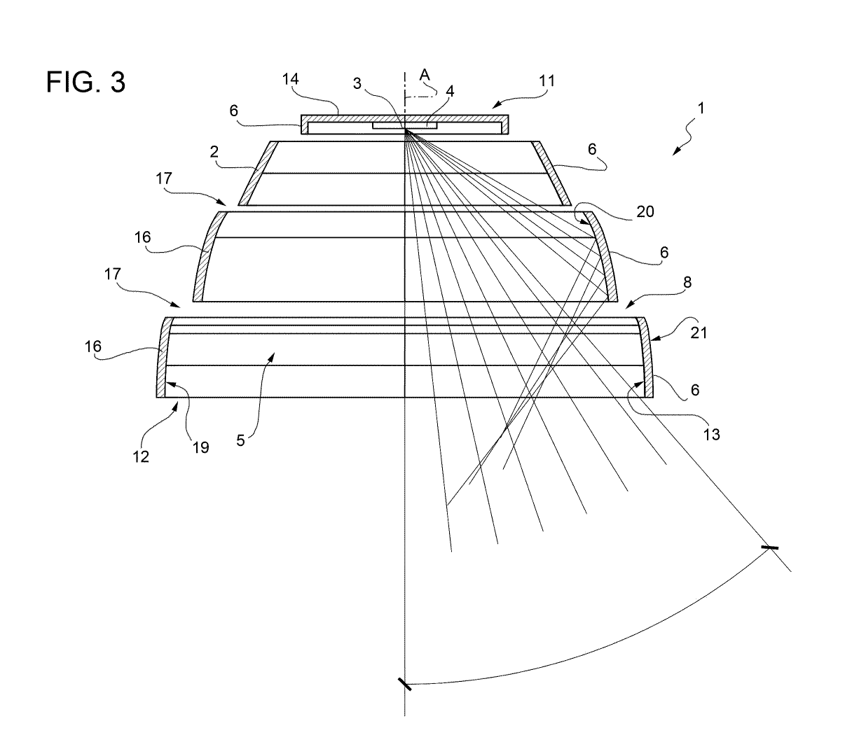

With reference to FIGS. 1-3, a LED lighting apparatus 1 comprises a body 2 and a LED light source 3, which may comprise one or more LEDs secured on a LED-carrier board 4.

In particular, apparatus 1 is a recessed lighting apparatus, i.e., intended to be housed in a recess obtained in a ceiling or wall.

It is understood that apparatus 1 may be used in other configurations, also associated with a lamp structure supporting body 2 to obtain, for example, a hanging lamp, a wall lamp, a desk lamp, a floor lamp, etc.

Body 2 substantially extends along and about an axis A.

In the example shown (but not necessarily), body 2 is a rotation body and axis A is a central symmetry axis.

Body 2 is made of a heat conductive material, e.g. a metal material; in a preferred embodiment, body 2 is made of die-casted aluminum. Body 2 advantageously consists of a single monolithic piece, for example obtained by means of aluminum die-casting.

Body 2 is an essentially cage-shaped hollow body and has an internal cavity 5, defined by annular portions 6 and rib longitudinal portions 7 interconnected and integrally joined together to form a grid structure provided with a plurality of cooling openings 8 defined between the portions 6, 7.

Body 2 is substantially cup-shaped and generally flared; in particular, body 2 broadens (i.e., it has an increasing diameter and cross section) from a root axial end 11, where the light source 3 is located, towards a free axial end 12, opposite to end 11 and provided with a light exit opening 13.

End 11 is closed by a transversal plate 14, substantially perpendicular to axis A and supporting the light source 3.

Board 4 is applied to an internal face, facing the cavity 5 and the light exit opening 13 of plate 14.

End 12 is provided with an annular peripheral edge 15 defining the light exit opening 13.

Body 2 is shaped so as to combine the optical function (to confer desired optical properties to the light emitted by the light source 3), the heat dissipation function (to dissipate heat generated by the light source 3) and the structural function (by providing apparatus 1 as a whole and the other components required for the operation thereof with mechanical support).

In particular, the portions 6, 7 are shaped so as to provide mechanical-structural support, to act as heat sinks to dissipate heat generated by the light source 3, and to form a plurality of optical sectors 16 coordinated with one another and operating on the light emitted by the light source 3.

In more detail, body 2 comprises a plurality of annular portions 6, which extend about axis A and are axially spaced apart from one another along axis A, and a plurality of rib longitudinal portions 7, extending between the annular portions 6.

The annular portions 6 extend about axis A and are axially spaced apart along axis A and radially staggered, having a diameter (cross section) which increases towards end 12.

The annular portions 6 are preferably spaced apart from one another both axially and radially, i.e., between each pair of consecutive annular portions 6 there is light both in the axial and the radial direction.

In other words, each annular portion 6 axially extends (along axis A) between two axially opposite end edges; and consecutive annular portions 6 have respective end edges facing one another, which are axially spaced apart from one another.

The annular portions 6 axially extend one after another along axis A and are separated from one another by respective annular slots 17 arranged about axis A and interrupted by the longitudinal portions 7.

The annular portions 6 extend one after another along axis A from end 11 towards end 12; each annular portion 6 has a diameter and cross section larger than the annular portion 6 preceding it and smaller than the annular portion 6 which follows.

Each annular portion 6 may have an increasing diameter and cross section along axis A (towards end 11).

A first annular portion 6 directly projects from plate 14 and surrounds the light source 3.

The annular portions 6 consist, for example, of respective loop-closed flat sheets; each annular portion 6 has an inner face 19, facing cavity 5 and defining an optical surface 20, and an outer face 21, opposite the inner face 19.

The optical surfaces 20 defined by faces 19 are curved, in particular generally concave, and/or slanted with respect to axis A and diverging towards end 12.

The optical surfaces 20 may be curved or faceted. Each annular portion 6 may have an optical surface 20 formed by surface portions having different geometry (for example, a different curvature radius, a different inclination with respect to the axis, etc.).

The annular portions 6 are shaped so as to direct practically the whole light emission of the light source 3 through the light exit opening 13, without losses through the slots 17.

In essence, all the light rays emitted by the light source 3 and which do not directly exit through the light exit opening 13 are intercepted by the optical surfaces 20 of the annular portions 6 and are reflected towards and through the light exit opening 13.

The optical surfaces 20 are shaped so as to deflect, into the light exit opening 13, all the light rays emitted by the light source 3 and hitting the optical surfaces 20.

The optical surfaces 20 are directly obtained onto the body 2 of apparatus 1.

In particular, the optical surfaces 20 are reflecting surfaces, for example made of the same material as body 2 or coated with a reflecting layer; the optical surfaces 20 may be finished by machining (polishing) and/or by means of surface post-treatments such as chrome plating, metallization, painting, etc., so as to increase the reflectance.

However, as a function of the desired lighting effect, the optical surfaces 20 may have different optical properties.

The rib longitudinal portions 7 bridge between the annular portions 6 and are substantially transverse to the annular portions 6.

In particular, the rib longitudinal portions 7 extend substantially parallel to axis A or slanted with respect to axis A between the annular portions 6.

Each longitudinal portion 7 bridges two or more annular portions 6. In the embodiment in FIGS. 1-3, each longitudinal portion 7 extends between end 11 and end 12, and joins all the annular portions 6.

The longitudinal portions 7 are angularly spaced apart from one another, about axis A.

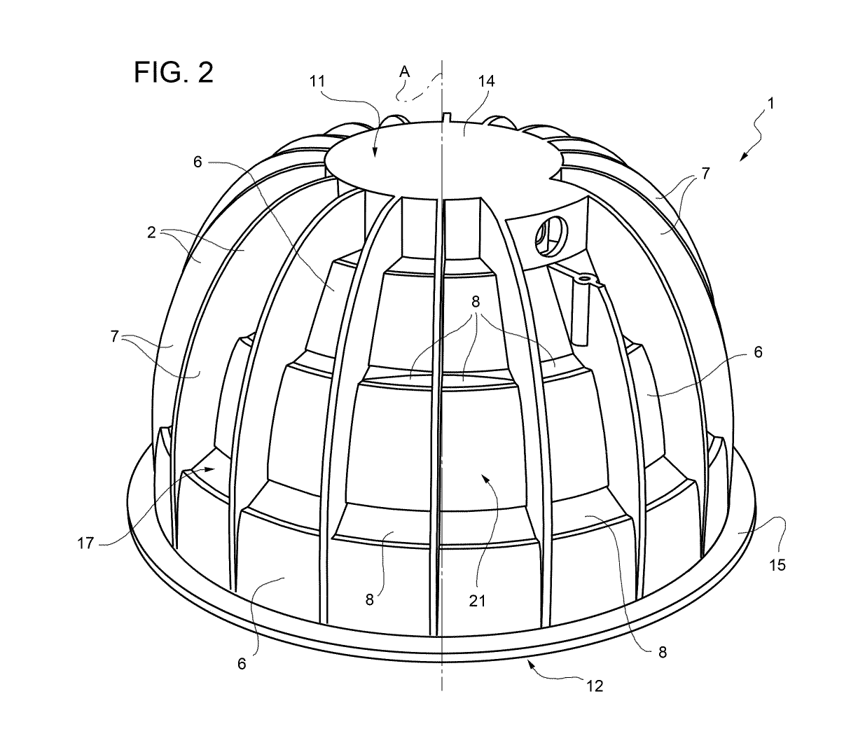

In the example shown in FIGS. 1-2 (but not necessarily), the longitudinal portions 7 radially project from the outer faces 21 of the annular portions 6 and radially protrude beyond the faces 21.

The longitudinal portions 7 divide each slot 17 into a plurality of slot sectors angularly adjacent to one another, defining respective cooling openings 8.

In use, body 2 forms a structural support member of apparatus 1, also providing possible supply and control components of apparatus 1 (not shown for simplicity) with support, and being also possibly used to secure (by means of special fasteners) apparatus 1 to a wall or lamp structure.

The body 2 itself ensures the dissipation of heat generated by the light source 3; the light source 3 is in contact with body 2 through plate 14, which is integrally joined with the portions 6, 7 of body 2, and thus efficiently transmits heat to the portions 6, 7, all of which are interconnected with one another; the efficient heat dissipation is also promoted by the openings 8 obtained between the portions 6, 7.

Body 2 also serves an optical function, in particular via the portions 7 provided with the optical surfaces 20, conferring the desired properties to the light emitted by the light source 3.

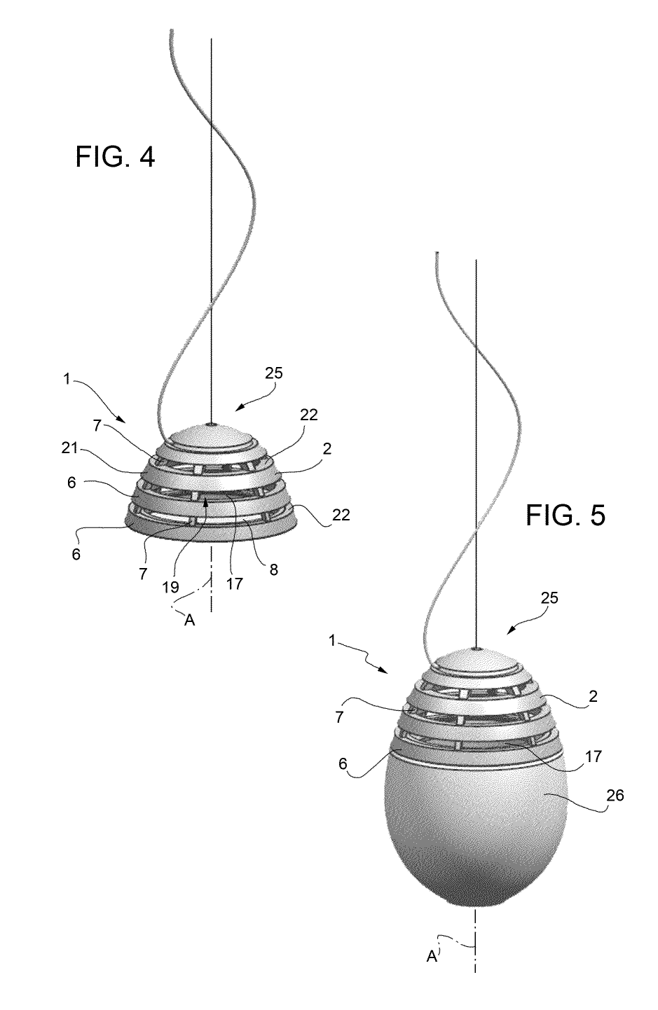

A further advantage of the lighting apparatus of the invention is the high versatility of use; in fact, body 2 is suitable to be made of a wide variety of formal and aesthetic solutions, while being combined in lamps of various type (hanging lamps, ceiling lamps, desk lamps, etc.), as shown in the embodiments in FIGS. 4 and 5.

In the embodiment in FIGS. 4-5, where like or similar details to those already described are indicated with the same numerals, apparatus 1 is configured for the use as a hanging lamp.

Again, apparatus 1 includes a cup-shaped hollow body 2, substantially extending along and about an axis A, made of a heat conductive material (for example, a metal material, in particular aluminum) and advantageously (but not necessarily) consisting of a single monolithic piece.

Again, body 2 is formed by annular portions 6 and rib longitudinal portions 7 interconnected and integrally joined with one another to form a grid structure provided with a plurality of cooling openings 8 defined between the portions 6, 7.

In the embodiment in FIGS. 4-5, the longitudinal portions 7 are arranged between respective sides 22, facing one another and defining the slots 17, of the annular portions 6 and do not radially project neither from the outer faces 21 of the annular portions 6, nor from the inner faces 19.

Apparatus 1 is provided with support means 25, which make the apparatus usable as a hanging lamp; it is understood that apparatus 1 may be provided with support means 25 of another type, to obtain lamps of a different type (wall lamps, floor lamps, desk lamps, etc.).

In the example in FIG. 5, apparatus 1 includes a diffuser 26, joined to the free axial end 12 of body 2 and having a shape which matches body 2.

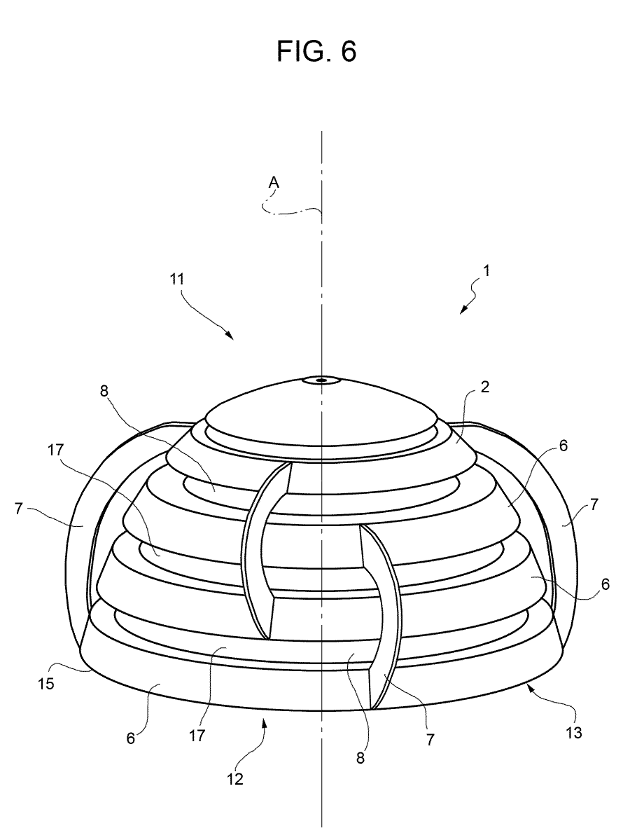

In the further embodiment in FIG. 6, the longitudinal portions 7 are configured and arranged so as to create optimized thermal paths.

In fact, the annular portions 6 need not to be all connected to one another by the longitudinal portions 6 thermally in series from the end 11 provided with the light source 3 to the end 12 provided with the light exit opening 13 (as in the embodiments in FIGS. 1-2 and 4-5); instead, pairs of even non-consecutive annular portions 6, omitting some intermediate annular portions 6, may be connected by longitudinal portions 7 in order to best thermally operate the masses of aluminum (or other material) available for the heat exchange. In fact, directly connecting the warmest annular portions 6, i.e., those nearest to the light source 3, with the coldest annular portions 6, i.e., those farthest from the light source 3, is convenient in order to optimize the heat transmission.

Body 2 thus includes a plurality of annular portions 6 extending one after another along axis A, and a plurality of longitudinal portions 7 bridging the annular portions 6; at least some longitudinal portions 7 bridge pairs of annular portions 6 which are not consecutive along axis A; at least some longitudinal portions 7 preferably connect the first annular portion 6, placed at end 11 and nearest to the light source 3, to the last annular portion 6 placed at end 12 and nearest to the light exit opening 13, and possibly to the penultimate annular portion 6; other longitudinal portions 7 connect the other annular portions 6 to one another, according to schemes which implement the most suitable thermal paths.

It is understood that changes and variations which do not depart from the scope of the appended claims may be made to the lighting apparatus described and illustrated herein.

1. A LED lighting apparatus, comprising a body having an internal cavity and extending substantially along and about an axis; and a LED light source housed in the cavity; the apparatus being characterized in that the body is formed by annular portions set about the axis and by rib longitudinal portions joining the annular portions, said portions being shaped so as to provide mechanical-structural support to the apparatus, to act as heat sinks to dissipate heat generated by the light source, and to form a plurality of optical sectors having respective optical surfaces coordinated with one another and operating on the light emitted by the light source.

2. An apparatus according to claim 1, wherein the body is a substantially cage-shaped hollow body and the portions are interconnected and joined integrally with one another to form a grid structure provided with a plurality of cooling openings defined between the portions.

3. An apparatus according to claim 1, wherein the body is substantially cup-shaped and generally flared, broadening from a root axial end, provided with the light source, towards a free axial end, opposite the root axial end and provided with a light exit opening.

4. An apparatus according to claim 1, wherein the body comprises a plurality of annular portions, extending about the axis and axially spaced from one another along the axis and/or radially staggered with respect to one another and defining respective optical sectors; and a plurality of rib longitudinal portions, substantially transverse to the annular portions and bridging between the annular portions.

5. An apparatus according to claim 1, wherein the annular portions are spaced apart from one another both axially and radially.

6. An apparatus according to claim 1, wherein the annular portions have respective inner faces facing towards the cavity and defining respective optical surfaces of the optical sectors; the optical surfaces being curved, in particular generally concave, and/or slanted with respect to the axis and diverging towards a light exit opening of the apparatus.

7. An apparatus according to claim 1, wherein the optical surfaces are curved and/or faceted, and/or are formed by respective surface portions having different geometry.

8. An apparatus according to claim 1, wherein the annular portions are separated from one another by respective annular slots, arranged about the axis and divided by the longitudinal portions in respective plurality of slot sectors angularly adjacent to one another and defining respective cooling openings.

9. An apparatus according to claim 8, wherein the annular portions are shaped so as to direct, via the respective optical surfaces, practically the whole light emission of the light source through the light exit opening, without losses through the slots.

10. An apparatus according to claim 8, wherein the optical surfaces are shaped so as to intercept substantially all the light rays emitted by the light source and that do not exit directly through the light exit opening, and to reflect them towards and through the light exit opening.

11. An apparatus according to claim 1, wherein the optical surfaces are reflecting surfaces, made of the same material of the body and/or coated with a reflecting layer and/or finished by machining and/or by surface post-treatments.

12. An apparatus according to claim 1, wherein the longitudinal portions are angularly spaced apart from one another about the axis; each longitudinal portion bridging two or more annular portions.

13. An apparatus according to claim 1, wherein at least some longitudinal portions bridge pairs of annular portions which are not consecutive along the axis.

14. An apparatus according to claim 1, wherein the body is made of a heat conductive material, for example a metal material, in particular in die-casted aluminum.

15. An apparatus according to claim 1, wherein the body consists of a single monolithic piece.
